(19) United States
(12) Patent Application Publication
(10) Pub. No.: US 2019/0308302 A1
(43) Pub. Date: Oct. 10, 2019

(54) WRENCH EXTENSION DEVICE

(71) Applicant: STANLEY BLACK & DECKER MEA FZE, Jebel Ali (AE)

(72) Inventors: ChihChiang LEE, Taichung City (TW); Wan-Chiang WANG, Taichung City (TW); Yi-Tung CHAN, Taichung City (TW); Ching-Yi TU, Taichung City (TW)

(21) Appl. No.: 16/380,352

(22) Filed: Apr. 10, 2019

(30) Foreign Application Priority Data
Apr. 10, 2018 (EP) 18166507.6

(51) Int. Cl. B25B 17/02

(52) U.S. Cl. CPC B25B 17/02; B25B 21/02

(57) ABSTRACT

A wrench extension device having an input and output, operably coupled together to transmit torque there between. The wrench extension device further includes a housing, with a first and second gear disposed therein. The first and second gear are operably coupled to one another with a chain. The wrench extension device further includes a rib disposed between the first and second gear. The rib includes a tapered portion that, along with an interior wall of the housing defines a tapered space. A tapered space defined by the tapered portion of the rib and the interior wall of the housing; wherein said tapered space is wide enough to allow a chain link to pass both horizontally and vertically, and wherein the area of said tapered space is large enough accommodate at least one additional chain links when the chain is slack as opposed to when it is taut.

This patent application claims priority to EP Patent Application No. 18166507.6, filed Apr. 10, 2018, which is hereby incorporated by reference in its entirety.

### FIELD OF THE INVENTION

The present invention relates to a wrench extension device, and more particularly to a wrench extension device for transferring torque with the use of an impact drill to a nut or bolt that is in a remote or difficult to reach position.

### BACKGROUND OF THE INVENTION

Wrench extension devices are commonly used to allow a user to transfer the torque from a wrench or drill to a nut or bolt that is in a remote or difficult to reach position. Typically wrench extension devices include an elongated housing that includes a first and second gear disposed therein. A continuous chain is operably engaged to both the first and second gear such that rotation of one gear causes the other gear to rotate as well. The first gear may include an input suitable for receiving a wrench or other torqueing device, such as an impact drill. The second gear may include an output for applying torque.

The use of powered torqueing devices, with a wrench extension device is not uncommon. Such powered torqueing devices may be driven hydraulically, pneumatically or with a motor. These devices give the user the advantage of speed and power. However, impact drills can cause wrench extension devices to fail. For example, when an operator uses a impact drill, he may quickly reach the maximum allowable torque for the output. At this point, torque is no longer applied to the output. At this point, the chain of the wrench extension device is under substantial tension. If torque continues to be applied, the links of the chain will be stretched. Thus, increasing the length of the chain. Eventually, the chain could break causing a backup of links within the housing. With no room to move, this back up could lead to a catastrophic failure of the housing, which could harm the user.

US Patent Publication 2016/0229046 seeks to address the foregoing issue by disclosing a wrench extension device crafted from a one-piece housing having apertures at either end of the wrench. Covers are then applied over the ends of the wrench. This design has the drawback of being difficult to machine and manufacture. Moreover, it may not completely solve the problem because the cover may fail.

Notwithstanding the usefulness of the above-described apparatuses, a need still exists for uncomplicated, easily utilized wrench device.

### SUMMARY OF THE INVENTION

An object of the present invention is to overcome one or more of the drawbacks of the common wrench extension devices. Another object of the present invention is to solve the problem the chain could break causing a backup of links within the housing. This implementation of the invention, in particular, may be desired, because the structure and arrangement can eliminate or reduce the chain breakage that could lead to a catastrophic failure of the housing, which could harm the user.

In accordance with one aspect of the present invention, the invention is a wrench extension device having an input and output, operably coupled together to transmit torque there between. The wrench extension device includes a housing, a first gear operably coupled to the input and a second gear operably coupled to the output, wherein both the first gear and second gear are disposed within the housing. A rib is also included, wherein said rib is disposed between the first gear and the second gear. The rib includes a guiding portion and a tapered portion, wherein the tapered portion is adjacent the first gear. The wrench extension device also includes a chain having multiple links. Said chain is operably engaged to both the first gear and the second gear such that when one gear rotates, the other gear rotates as well. The chain is disposed in a space defined by the rib and an interior wall of the housing. The wrench extension device also includes a guiding space defined by the guiding portion of the rib and the interior wall of the housing, wherein said guiding space is wide enough to allow a chain link to pass horizontally but not vertically. The wrench extension device also includes a tapered space defined by the tapered portion of the rib and the interior wall of the housing. The tapered space is wide enough to allow a chain link to pass both horizontally and vertically. The area of the tapered space is large enough accommodate at least one additional chain links when the chain is slack as opposed to when it is taut.

The terminology used herein is for the purpose of describing implementations or embodiments only and is not intended to be limiting of the invention. As used herein, the singular forms, “a”, “an” and “the” are intended to include the plural forms as well, unless the context clearly indicates otherwise. It will be further understood that the root terms “can”, “include”, “can include”, “may”, and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein “connected” or “attached” includes operation or physical, whether direct or indirect, affixed or coupled, as for example a first gear operably coupled to the input and a second gear operably coupled to the output. Thus, unless specified, “connected” or “attached” is intended to embrace any operationally functional connection.

As used herein “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to accompanying drawings which are provided for illustration purposes as representative of specific exemplary embodiments in which the invention may be practiced. Given the following description of the specification and drawings, the apparatus and methods should become evident to a person of ordinary skill in the art. Further areas of applicability of the present teachings will become apparent from the description provided herein. It is to be understood that other embodiments can be utilized and that structural changes based on presently known structural and/or functional equivalents can be made without departing from the scope of the invention.

### BRIEF DESCRIPTION OF THE DRAWINGS

The above-mentioned and other features and advantages of this invention, and the manner of attaining them, will become more apparent and the invention will be better understood by reference to the following descriptions of embodiments of the invention taken in conjunction with the accompanying drawings:

FIG. 1a is a cut away view of the interior of a wrench extension device of the prior art.

FIG. 1b is a plan view of a wrench extension device of the prior art.

FIG. 2 is an exploded view of a first embodiment of a wrench extension device according to the present invention.

FIG. 3a is a cut away view of the interior of the first embodiment of the wrench extension device according to the present invention showing the chain in a taut position.

FIG. 3b is a cut away view of the interior of the first embodiment of the wrench extension device according to the present invention showing a broken chain in a slack position.

FIG. 4 is a plan view of a second embodiment of a wrench extension device according to the present invention.

FIG. 5 is a plan view of a third embodiment of a wrench extension device according to the present invention.

Corresponding reference characters indicate corresponding parts throughout the several views. The exemplifications set out herein illustrate embodiments of the present invention, and such exemplifications are not to be construed as limiting the scope of the present invention in any manner.

### DETAILED DESCRIPTION OF THE INVENTION

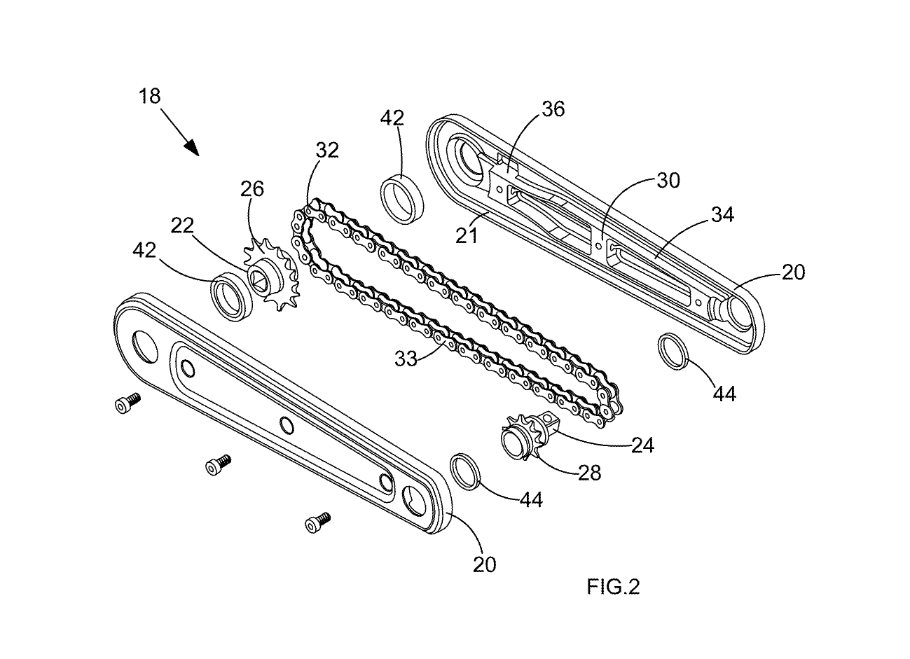

A detailed description of apparatuses, methods, and systems, consistent with embodiments of the present disclosure is provided below to FIGS. 2-5. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

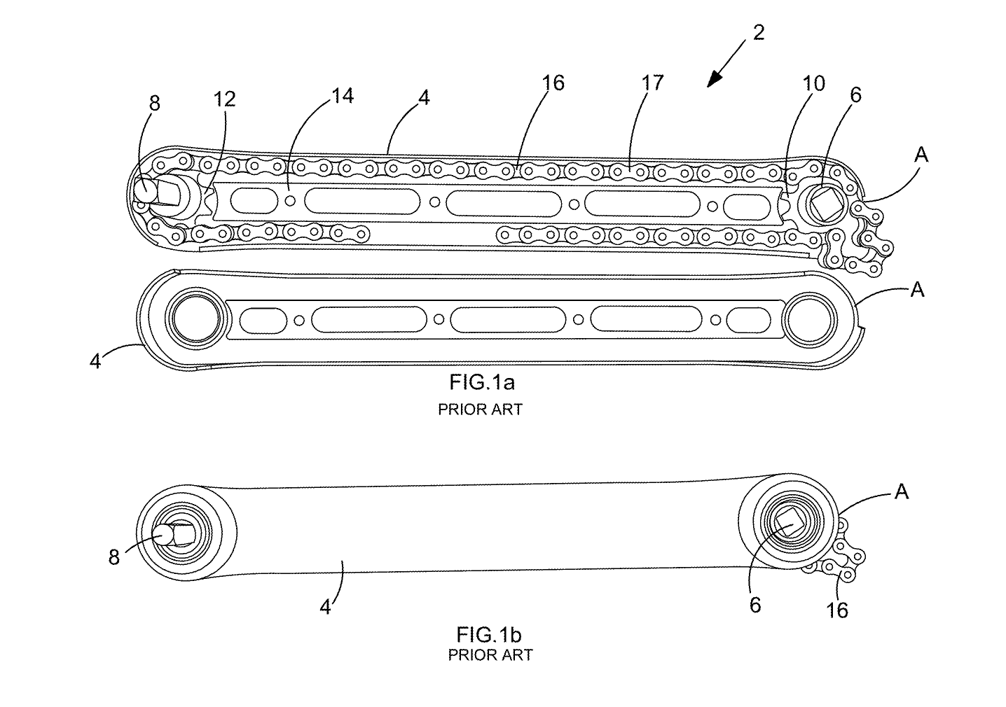

Now referring to FIG. 1a, there is illustrated a plan view of a prior art extension wrench in a disassembled state. The extension wrench 2 includes a housing 4. In this example, the housing 4 is a two-piece “clam shell” type housing. The extension wrench of the prior art also includes an input 6, and an output 8. The input 6 is operably engaged to a first gear 10. Similarly, the output 8 is operably engaged to a second gear 12. Extension wrench 2 also includes a rib 14. The prior art extension wrench also includes a chain 16 which is configured to operably couple the first and second gears 10, 12, such that when torque is applied to the input 6, torque is delivered at the output 8. The chain 16 of FIG. 1a is shown as being broken. When this happens, if torque is still applied to the input 6, the chain 16 may break through the housing 4. In FIGS. 1a and 1b, the chain 16 has broken through the housing 4 at point A.

Turning now to FIG. 2, which depicts an exploded view of a first embodiment of a wrench extension device 18 according to the present invention. The wrench extension device includes a housing 20. As shown, the housing 20 is of a two piece “clam shell” design. However, those skilled in the art will recognize that the housing 20 may also be manufactured as a single integrated structure. The wrench extension device 18 also includes an input 22 and an output 24. Input 22 is operably associated with a first gear 26. Similarly, output 24 is operably associated with a second gear 28. The wrench extension device also includes a rib 30 and a chain 32. Chain 32, which may include multiple links 33, is configured to operably engage the first gear 26 and second gear 28, such that when torque is applied to input 22, torque is delivered at output 24.

Those skilled in the art will recognize that the first gear 26 and the second gear 28 may be sized in a variety of ways. The first gear 26 and second gear 28 may be identical or one gear may be larger than the other. In a preferable embodiment as shown in FIG. 2, first gear 26 is larger than second gear 28. In a preferable embodiment, the gear ratio between first gear 26 and second gear 28, may be 13:8.

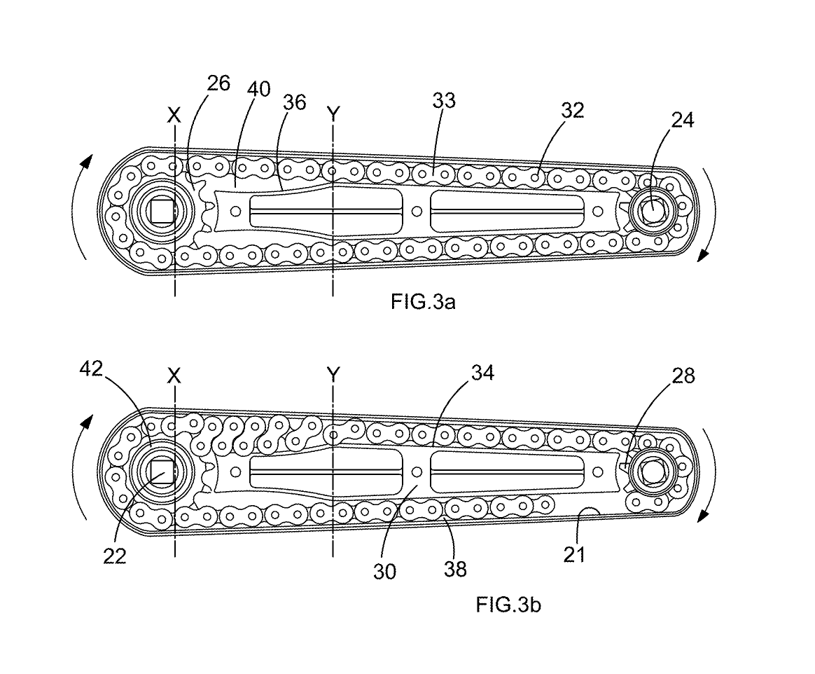

As better shown in FIGS. 3a and 3b, rib 30 may be integral with housing 20. However, in alternate embodiments the rib 30 may be a separate structure. Rib 30 includes a guiding portion 34 and a tapered portion 36. In a preferred embodiment, the tapered portion 36 is adjacent the first gear 26. The rib 30 and an interior wall 21 of the housing 20 defines the space in which the chain 32 can be disposed. More specifically, the interior wall 21 and guiding portion 34 of rib 30 defines a guiding space 38 that is wide enough to allow a chain link 33 to pass through in a horizontal position but not in a vertical position. The interior wall 21 and tapered portion 36 of rib 30 define a tapered space 40 that is wide enough to allow a chain link 33 to pass in either a horizontal position or a vertical position. Additionally, the area of tapered space 40 is large enough to accommodate at least one additional chain link 33 when the chain 32 is slack as opposed to when it is taut.

FIGS. 3a and 3b demonstrate how the area of the tapered space 40 is large enough to accommodate at least one additional chain link 33. As shown by the arrows, the chain 32 in both FIGS. 3a and 3b moves in a clockwise direction. Thus, as oriented, the chain 32 moves from the first gear 26 to the second gear 28 along the top of the wrench extension device 18. In FIG. 3a, where chain 32 is unbroken and taut. Between reference lines X and Y, there are seven chain links that span the tapered space. In contrast, in FIG. 3b, the chain 32 is broken and slack, particularly between reference lines X and Y. Here the chain 32 no longer advances and begins to back up in the tapered space 40. Thus, in FIG. 3b, twelve links fit into the tapered space.

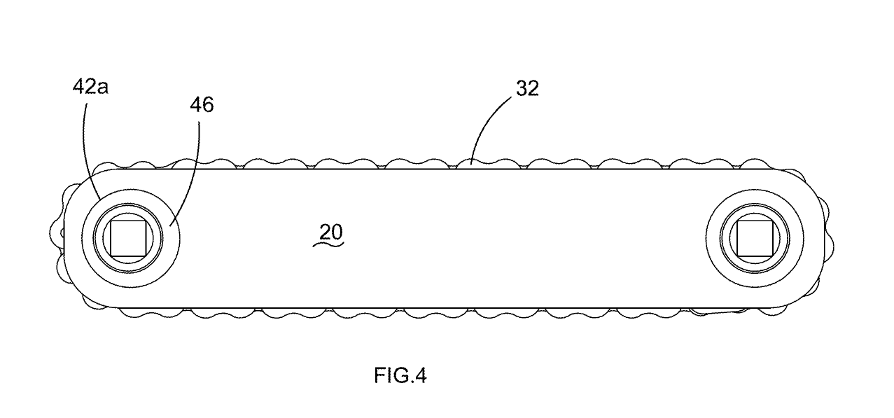

The wrench extension device may also include one or more bushings 42, 44, which are associated respectively with the first gear 26 and second gear 28. Bushings 42, 44 help to facilitate the rotation of the first and second gears 26, 28. In an alternate embodiment, as shown in FIG. 4, bushing 42a is shown with an eccentric portion 46. Bushing 42a is configured to be rotatably adjustable. As it rotates, the eccentric portion 46 applies (or relieves) pressure to the housing 20, which in turn selectively increases (or decreases) the distance between the input first gear 26 and the second gear 28. By increasing or decreasing the distance between the first gear 26 and second gear 28, a user can adjust the tension on chain 32. As shown in FIG. 4, the eccentric portion 46 is at the “3 o′clock” position. In this position, the first gear 26 is urged to be slightly farther away from the second gear 28. Correspondingly, the tension applied to chain 32 is slightly greater than if the eccentric portion 46 is at the 12 o'clock or 6 o'clock position.

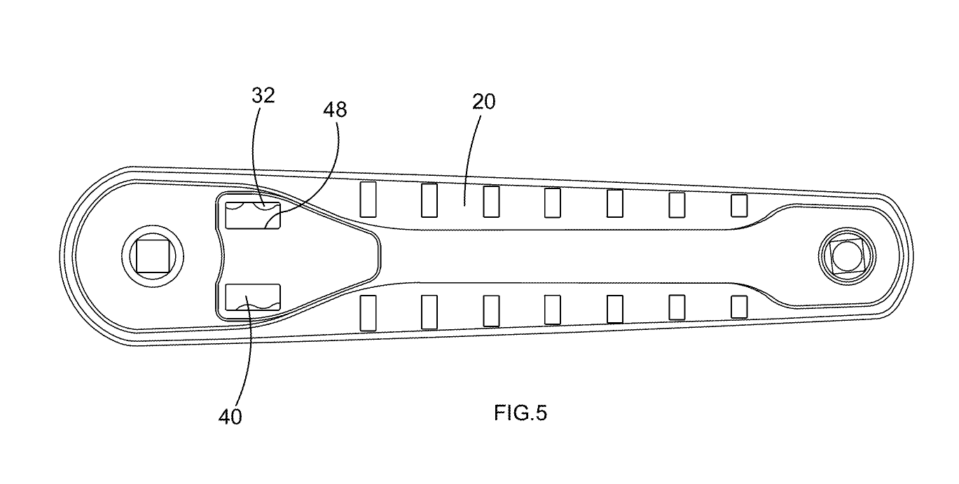

In yet another embodiment, as shown in FIG. 5, the housing 20 may include one or more windows 48. Window 48 allow for visual access inside the wrench extension device 18. In a preferable embodiment, window 48 is positioned to allow visual access to the tapered space 40. By inspecting the tapered space 40 a user can determine whether the chain 32 is beginning to sag as it spans the tapered space 40. If this happens, a user may be able to increase the tension in the chain 32 by adjusting the eccentric bushing 42a as outlined above.

The wrench extension device 18 as disclosed herein in the various embodiments is designed to allow a user to apply torque to a remote or difficult to reach work piece (e.g., nut or bolt). In order to achieve this, a user affixes a torque applying device (not shown) such as a ratchet to the input 22 of the wrench extension device 18 and a socket (not shown) to the output 24. The wrench extension device 18 is then put into position wherein the socket is in corresponding engagement with the work piece. By applying torque to the input 22, a first gear 26 and second gear 28 begin to rotate via chain 32 which connects the two gears.

Wrench extension devices are often used with a powered tool such as a hydraulic, motor driven, or pneumatic wrench to supply torque to the input. These powered tools can apply a significantly increased amount of torque to the output in a short amount of time. Often, a user will reach the maximum allowed torque of a workpiece without realizing it. When this happens, the work piece may no longer be tightened. However, if torque continues to be supplied to the input, a tremendous amount of strain gets applied to the chain. This leads to the lengthening of the chain and/or breaking of the chain. In prior art wrench extension devices, such as that shown in FIGS. 1a and 1b, if torque continues to be applied to input 6 after chain 16 is lengthened or broken, chain links 17 may apply increased pressure to the rib 14 and ultimately have nowhere relieve said pressure. When this happens, the links 17 of chain 16 may burst through the housing 4. This is a dangerous situation that has the potential to harm a user.

The present invention of the wrench extension device 18 reduces the potential for such a catastrophic failure of the housing. This is achieved by providing a tapered space 40 defined by a tapered portion 36 of rib 30 and an interior wall 21 of the housing 20. In a preferred embodiment, the tapered space is adjacent the first gear 26. The tapered space 40 is wide enough to allow a chain link 33 of chain 32 to pass through in either a horizontal or a vertical position. Additionally, the area of the tapered space 40 is large enough to accommodate at least one additional chain link 33 when the chain 32 is slack as opposed to when it is taut. In a preferable embodiment, the area of the tapered space is large enough to accommodate five additional chain links 33 when the chain 32 is broken or slack than when it is taut.

In operation, if a user chooses to apply torque to the input 26 with a powered tool and the chain 32 lengthens and breaks as described above, instead of applying pressure to the rib 30 and bursting through the housing 20, the chain will safely back up into the tapered space 40 as shown in FIG. 3b. In this way, the risk of injury associated with a catastrophic failure of the housing 20 is reduced.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described can include various combinations and/or sub-combinations of the functions, components and/or features of the different implementations described.

We claim:

1. A wrench extension device having an input and output, operably coupled together to transmit torque there between, comprising:
a housing;
a first gear operably coupled to the input and a second gear operably coupled to the output, wherein both the first gear and second gear are disposed within the housing;
a rib disposed between the first gear and the second gear, and having a guiding portion and a tapered portion, wherein the tapered portion is adjacent the first gear;
a chain having multiple links, and being operably engaged to both the first gear and the second gear such that when one gear rotates, the other gear rotates as well, and wherein said chain is disposed within a space defined by the rib and an interior wall of the housing;
a guiding space defined by the guiding portion of the rib and the interior wall of the housing, wherein said guiding space is wide enough to allow a chain link to pass horizontally but not vertically; and
a tapered space defined by the tapered portion of the rib and the interior wall of the housing; wherein said tapered space is wide enough to allow a chain link to pass both horizontally and vertically, and wherein the area of said tapered space is large enough accommodate at least one additional chain links when the chain is slack as opposed to when it is taut.

2. The wrench extension device of claim 1, wherein the housing is made of a two-piece claim shell design.

3. The wrench extension device of claim 2, wherein the rib is integrated into the housing.

4. The wrench extension device of claim 1, wherein the first gear is larger than the second gear.

5. The wrench extension device of claim 4, wherein the gear ratio between the first and second gear is 13:8.

6. The wrench extension device of claim 1, further comprising at least one adjustable eccentric bushing operably coupled to one of the first or second gears and configured to selectively apply or relieve tension in the chain.

7. The wrench extension device of claim 1, wherein the housing includes a window configured to allow visual inspection inside the housing.
